(19) United States
(12) Patent Application Publication
(10) Pub. No.: US 2026/0149162 A1
(43) Pub. Date: May 28, 2026

(54) DIELECTRIC FILTER AND COMMUNICATION DEVICE

(71) Applicant: HUAWEI TECHNOLOGIES CO., LTD., Shenzhen (CN)

(72) Inventors: Maomao Jiang, Shanghai (CN); Xiaoliang Du, Shanghai (CN); Bengui Yuan, Shanghai (CN); Chengqiang Li, Shanghai (CN); Junyu Wang, Shenzhen (CN)

(73) Assignee: HUAWEI TECHNOLOGIES CO., LTD., Shenzhen (CN)

(21) Appl. No.: 19/452,773

(22) Filed: Jan. 19, 2026

Related U.S. Application Data
(63) Continuation of application No. PCT/CN2024/095684, filed on May 28, 2024.

(30) Foreign Application Priority Data
Jul. 17, 2023 (CN) 202310876692.5

(51) Int. Cl. H01P 7/10; H01P 1/20; H01P 1/207

(52) U.S. Cl. CPC H01P 7/10; H01P 1/2002; H01P 1/207

(57) ABSTRACT

A dielectric filter is provided including at least two connected dielectric resonators and a hole group formed between two adjacent dielectric resonators. Each dielectric resonator includes a dielectric body and a resonant cavity. The dielectric body includes a top surface and a bottom surface along a first direction Z of the dielectric filter. The resonant cavity runs through the top surface or the bottom surface. The dielectric body further includes a first side surface and a second side surface along a second direction Y. Each hole group includes a first hole and a second hole. Two ends of the first hole respectively run through the top surface and the bottom surface. The second hole runs through at least one of the first side surface and the second side surface. Projections of the first hole and the second hole intersect along a third direction X of the dielectric filter.

### CROSS-REFERENCE TO RELATED APPLICATIONS

This application is a continuation of International Patent Application No. PCT/CN 2024/095684, filed on May 28, 2024, which claims priority to Chinese Patent Application No. 202310876692.5, filed on Jul. 17, 2023. The disclosures of the aforementioned applications are hereby incorporated by reference in their entireties.

### TECHNICAL FIELD

This application relates to the field of communication technologies, and in particular, to a dielectric filter and a communication device.

### BACKGROUND

With development of communication technologies, the requirement for reducing power consumption of communication systems is increasingly strong. Dielectric filters are increasingly widely used due to advantages such as small volumes, small insertion losses, large withstand powers, and low costs. The dielectric filter is typically formed by coupling several dielectric resonators. Because coupling among a plurality of dielectric resonators can enlarge a magnetic field distribution area of the entire dielectric filter, the coupling can cause reduction in a suppression capability for a high-order harmonic wave band. That is, a remote suppression capability of the dielectric filter is poor, failing to meet user requirements. In conventional technologies, an additional low-pass filter is typically added to cooperate with a dielectric filter to suppress high-order harmonic waves. However, the additional low-pass filter accordingly increases insertion losses and increases power consumption of a communication system. This is not conducive to the design requirement of reducing the system power consumption.

### SUMMARY

This application provides a dielectric filter and a communication device to resolve a problem in conventional technologies that a dielectric filter has a poor remote suppression capability and an additional low-pass filter is needed for remote suppression.

A first aspect of embodiments of this application provides a dielectric filter. The dielectric filter includes at least two dielectric resonators connected to each other and includes a hole group. Each of the dielectric resonators includes a dielectric body and a resonant cavity. The dielectric body includes a top surface and a bottom surface along a first direction Z of the dielectric filter. The resonant cavity runs through the top surface or the bottom surface. The dielectric body further includes a first side surface and a second side surface along a second direction Y of the dielectric filter. The hole group is disposed between two adjacent dielectric resonators. Each hole group includes a first hole and a second hole. Two ends of the first hole respectively run through the top surface and the bottom surface. The second hole runs through at least one of the first side surface and the second side surface. Projections of the first hole and the second hole intersect along a third direction X of the dielectric filter.

In this application, the hole group is disposed between two adjacent dielectric resonators, and a magnetic field between the two adjacent dielectric resonators may be cut by using the hole group, so that a magnetic field distribution area of the dielectric filter is reduced, thereby improving a suppression capability to a high-order harmonic wave, reducing coupling strength between high-order modes, and improving a remote suppression capability of the dielectric filter. In addition, because the projections of the first hole and the second hole intersect in the third direction X, the hole group may generate components along various directions in a plane perpendicular to the third direction X, and can a cut magnetic field between two adjacent dielectric resonators in various directions, so that the magnetic field between the two adjacent dielectric resonators can be cut more fully, thereby further reducing the magnetic field distribution area of the dielectric filter, further reducing the coupling strength between the high-order modes of the high-order harmonic wave, and further improving the remote suppression capability of the dielectric filter. In addition, compared with an existing conventional dielectric filter requiring an additional low-pass filter to cooperate in suppressing a high-order harmonic wave, the dielectric filter in this embodiment of this application has a strong remote suppression capability, and no additional low-pass filter needs to be added to cooperate with the dielectric filter to suppress the high-order harmonic wave, thereby reducing manufacturing costs, and reducing insertion losses caused by the addition of the low-pass filter, reducing power consumption of a communication device, and meeting a use requirement of a user, that is, facilitating a design requirement of reducing insertion losses by removing a low-pass filter from a communication device system, and improving user experience.

In an embodiment, an included angle between the projections of the first hole and the second hole in the third direction X is an intersection angle, and at least two intersection angles differ in magnitude.

In this solution, by changing an intersection angle between the first hole and the second hole of the hole group, a resonance frequency of the hole group can be adjusted. Therefore, the impact of the resonance frequency of the hole group on a remote suppression degree of the dielectric filter can be reduced while it is ensured that the hole group fully cuts the magnetic field between the two adjacent dielectric resonators, thereby improving the remote suppression capability of the dielectric filter. Particularly, in a structure in which there are a plurality of hole groups in the dielectric filter, intersection angles in the plurality of hole groups are different so that resonance frequencies of the plurality of hole groups are different, thereby reducing mutual excitation between the resonance frequencies of the plurality of hole groups to reduce impact on the dielectric filter and effectively improve the remote suppression capability of the dielectric filter.

In an embodiment, in the at least one hole group, the first hole is in communication with the second hole to reduce space occupied by the hole group in the third direction X, thereby facilitating a miniaturization of the dielectric filter.

In an embodiment, in at least one hole group, the first hole and the second hole are staggered so that a process requirement can be further reduced, formation of the hole group is more convenient, and flexibility is higher. In addition, when there is another structure or component between two adjacent dielectric resonators, the hole group of the structure may enable more proper formation of the first hole and the second hole in space between the two adjacent dielectric resonators, thereby facilitating the miniaturization design of the dielectric filter.

In an embodiment, in the at least one hole group there are a plurality of first holes, and at least one of the first holes is in communication with the second hole to further improve design flexibility of the structure of the hole group, improve spatial rationality of the hole group between the two adjacent dielectric resonators, further improve design flexibility and an adjustment range of a frequency of the hole group, and reduce impact of the frequency of the hole group on a remote suppression degree of the dielectric filter.

In an embodiment, in at least one hole group there are a plurality of second holes, and at least one of the second holes is in communication with the first hole to further improve design flexibility of the structure of the hole group, improve spatial rationality of the hole group between the two adjacent dielectric resonators, further improve design flexibility and an adjustment range of a frequency of the hole group, and reduce impact of the frequency of the hole group on a remote suppression degree of the dielectric filter.

In an embodiment, one of at least two adjacent dielectric resonators includes a first co-fired surface, another includes a second co-fired surface, and the first co-fired surface is opposite to the second co-fired surface; the first co-fired surface is provided with a first groove; the second co-fired surface is provided with a second groove, the second groove corresponds to the first groove; the first co-fired surface is connected to the second co-fired surface, and the first groove and the second groove are enclosed to define the first hole and/or the second hole.

In this solution, the first groove and the second groove corresponding to the first hole and/or the second hole of the hole group may be prepared in advance on the first co-fired surface and the second co-fired surface so that when the two adjacent dielectric resonators are connected by using the first co-fired surface and the second co-fired surface, the first groove and the second groove are engaged and surrounded to form the first hole and/or the second hole, thereby facilitating formation of the first hole and/or the second hole with a relatively complex structure, and improving the design flexibility of the dielectric filter.

In an embodiment, at least two adjacent dielectric resonators are integrally formed so that the dielectric filter is prepared in a large quantity and preparation costs are reduced.

In an embodiment, the first hole is a straight through hole or a curved through hole to improve design flexibility of the first hole.

In an embodiment, a cross section of the first hole is one of rectangular, circular, elliptical, triangular, or T-shaped, to facilitate processing and formation of the first hole.

In an embodiment, the second hole is a straight hole or a curved hole to improve design flexibility of the second hole.

In an embodiment, a cross section of the second hole is one of rectangular, circular, elliptical, triangular, or T-shaped, to facilitate processing and formation of the second hole.

In an embodiment, a surface of at least one of the resonant cavity, the first hole, and the second hole is coated with a metallized layer so that leakage of harmonic energy can be reduced, reliable transmission of a signal can be ensured, and signal transmission efficiency can be improved.

A second aspect of embodiments of this application further provides a communication device including the dielectric filter according to any one of the foregoing embodiments. Because the dielectric filter has the foregoing technical effect, the communication device including the dielectric filter should also have the corresponding technical effect. Details are not described herein again.

It should be understood that the foregoing general descriptions and the following detailed descriptions are merely used as an example, and should not limit this application.

### BRIEF DESCRIPTION OF DRAWINGS

FIG. 1 is a diagram of a structure of a dielectric filter according to an embodiment;

FIG. 2 is a diagram of a structure of a dielectric filter according to an embodiment;

FIG. 3 is a diagram of a structure of a dielectric filter according to an embodiment;

FIG. 4 is a diagram of a structure of a dielectric filter according to an embodiment;

FIG. 5 is a diagram of a structure of a dielectric filter according to an embodiment;

FIG. 6 is a diagram of a structure of a dielectric filter according to an embodiment;

FIG. 7 is a diagram of a structure of a dielectric filter according to an embodiment;

FIG. 8 is a diagram of a structure of a dielectric filter according to an embodiment\;

FIG. 9 is a diagram of a structure of a dielectric filter according to an embodiment\;

FIG. 10 is a diagram of a structure of a dielectric filter according to an embodiment\;

FIG. 11 is a diagram of a structure of a dielectric filter according to an embodiment; and

FIG. 12 is a simulation comparison diagram of a remote suppression curve of a dielectric filter and a remote suppression curve of a conventional dielectric filter according to an embodiment.

### REFERENCE NUMERALS

10—dielectric filter;
1—dielectric resonator;
   11—dielectric body;
   12—resonant cavity;
   13—top surface;
   14—bottom surface;
   15—first side surface;
   16—second side surface;
2—hole group;
   21—first hole;
   22—second hole;
3—first dielectric resonator;
4—second dielectric resonator;
   41—first co-fired surface;
   42—first groove;
5—third dielectric resonator;
   51—second co-fired surface;
   52—second groove;
6—fourth dielectric resonator;
X—third direction;
Y—second direction; and
Z—first direction.

The accompanying drawings herein are incorporated into this specification and constitute a part of this specification to show embodiments in accordance with this application and are used together with this specification to explain the principle of this application.

### DESCRIPTION OF EMBODIMENTS

To better understand technical solutions of this application, the following describes embodiments of this application in detail with reference to the accompanying drawings.

In descriptions of this application, unless otherwise specified and limited, the terms “first” and “second” are merely intended for a purpose of description, and cannot be understood as an indication or implication of relative importance. Unless otherwise specified or stated, the term “a plurality of” means two or more than two. The terms “connection”, “fastening”, and the like all should be understood in a broad sense. For example, “connection” may be a fastened connection; or may be a detachable connection, an integrated connection, or an electrical connection; or may be a direct connection; or may be an indirect connection through an intermediate medium. A person of ordinary skill in the art may understand the meanings of the foregoing terms in this application based on a particular case.

The following further describes this application in detail with reference to particular embodiments and the accompanying drawings.

With development of communication technologies, the requirement for reducing power consumption of communication systems is increasingly strong. Dielectric filters are increasingly widely used due to advantages such as small volumes, small insertion losses, large withstand powers, and low costs. The dielectric filter is typically formed by coupling several dielectric resonators. Because coupling among a plurality of dielectric resonators can enlarge a magnetic field distribution area of the entire dielectric filter, causing reduction in a suppression capability for a high-order harmonic wave section. That is, a remote suppression capability of the dielectric filter is poor, failing to meet user requirements.

In conventional technologies, an additional low-pass filter is generally added to cooperate with a dielectric filter to suppress a high-order harmonic wave. However, the additional low-pass filter correspondingly increases insertion losses. Consequently, power consumption of a communication system increases. This is not conducive to a design requirement of reducing the power consumption of the system.

To resolve the foregoing technical problem, an embodiment of this application provides a dielectric filter to improve a remote suppression capability of the dielectric filter so that no additional low-pass filter needs to be added to cooperate with the dielectric filter to suppress a high-order harmonic wave. The dielectric filter may be used in a communication device. Because the remote suppression capability of the dielectric filter is strong, no additional low-pass filter needs to be added to suppress the high-order harmonic wave, thereby reducing insertion losses of a communication device system, reducing power consumption of the communication device, and meeting a use requirement of a user. The communication device may be but is not limited to a duplexer, a multiplexer, a base station, a terminal device, or the like. A form of the communication device is not specially limited in this embodiment of this application.

To describe the technical solutions in embodiments of this application more clearly, the following describes in detail, with reference to the accompanying drawings, the dielectric filter and the communication device that are provided in embodiments of this application.

FIG. 1 is a diagram of a structure of a dielectric filter 10 according to an embodiment. As shown in FIG. 1, the dielectric filter 10 includes at least two dielectric resonators 1 connected to each other. A quantity of dielectric resonators 1 may be designed based on an actual requirement and is not limited herein. Each of the dielectric resonators 1 includes a dielectric body 11 and a resonant cavity 12. The dielectric body 11 includes a top surface 13 and a bottom surface 14 along a first direction Z of the dielectric filter 10. The resonant cavity 12 runs through the top surface 13 or the bottom surface 14. After a radio signal enters the resonant cavity 12, a signal with a specific frequency passes through the resonant cavity 12 through selection, thereby implementing a filtering function.

As shown in FIG. 1, the dielectric filter 10 in this embodiment further includes a hole group 2. The dielectric body 11 further includes a first side surface 15 and a second side surface 16 along a second direction Y of the dielectric filter 10. The hole group 2 is formed between two adjacent dielectric resonators 1. A magnetic field between the two adjacent dielectric resonators 1 may be cut by using the hole group 2 so that a magnetic field distribution area of the dielectric filter 10 is reduced, thereby improving a suppression capability of a high-order harmonic wave, reducing coupling strength between high-order modes, and improving a remote suppression capability of the dielectric filter 10.

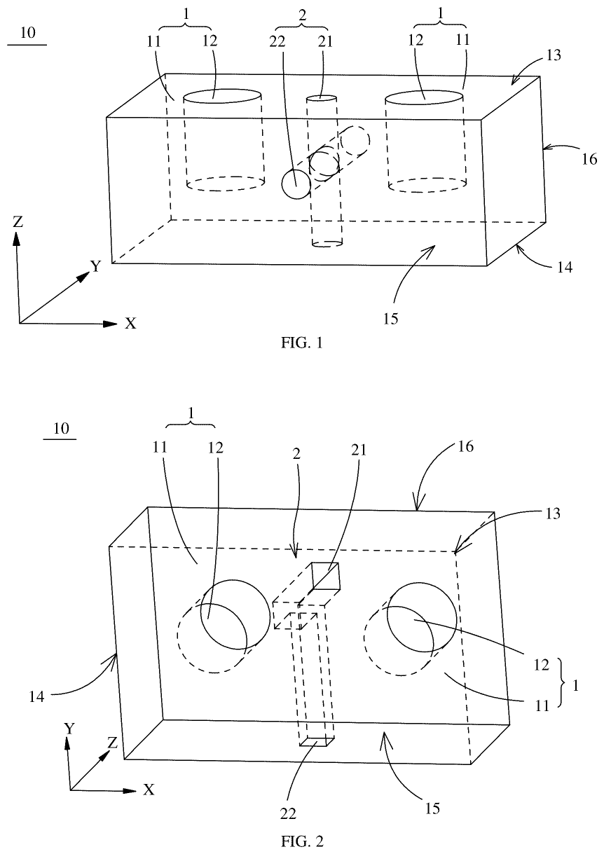

Further, as shown in FIG. 1 and FIG. 2, FIG. 2 is a diagram of a structure of a dielectric filter 10 according to an embodiment. Each hole group 2 includes a first hole 21 and a second hole 22. Two ends of the first hole 21 respectively run through the top surface 13 and the bottom surface 14. The second hole 22 runs through at least one of the first side surface 15 and the second side surface 16. Projections of the first hole 21 and the second hole 22 intersect along a third direction X of the dielectric filter 10.

In the hole group 2 of the dielectric filter 10 shown in FIG. 1, two ends of the second hole 22 respectively run through the first side face 15 and the second side face 16, in other words, the second hole 22 may be a through hole. In the hole group 2 of the dielectric filter 10 shown in FIG. 2, one end of the second hole 22 runs through the first side face 15, and the other end does not run through the second side face 16. Certainly, one end of the second hole 22 may alternatively run through the second side face 16, and the other end does not run through the first side face 15, in other words, the second hole 22 may alternatively be a blind hole. A structure of the second hole 22 may be set based on an actual requirement and is not limited herein.

In this embodiment, as shown in FIG. 1, because the projections of the first hole 21 and the second hole 22 intersect in the third direction X, the hole group 2 may generate components along various directions in a plane perpendicular to the third direction X, and can cut a magnetic field between two adjacent dielectric resonators 1 in various directions so that the magnetic field between the two adjacent dielectric resonators 1 can be cut more fully, thereby further reducing the magnetic field distribution area of the dielectric filter 10, further reducing the coupling strength between the high-order modes of the high-order harmonic wave, and further improving the remote suppression capability of the dielectric filter 10. In addition, compared with an existing conventional dielectric filter requiring an additional low-pass filter to cooperate in suppressing a high-order harmonic wave, the dielectric filter 10 in this embodiment of this application has a strong remote suppression capability, and no additional low-pass filter needs to be added to cooperate with the dielectric filter 10 to suppress the high-order harmonic wave, thereby reducing manufacturing costs, reducing insertion losses caused by the addition of the low-pass filter, reducing power consumption of a communication device, and meeting a use requirement of a user, that is, facilitating a design requirement of reducing insertion losses by removing a low-pass filter from a communication device system and improving user experience.

It should be noted that in the dielectric filter 10 shown in FIG. 1, only a case in which one hole group 2 is formed between two adjacent dielectric resonators 1 is shown. Optionally, when the dielectric filter 10 has three or more dielectric resonators 1, a hole group 2 is formed between any two adjacent dielectric resonators 1, or a hole group 2 may be formed between some of two adjacent dielectric resonators 1. Further, a quantity of hole groups 2 between two adjacent dielectric resonators 1 may be one, two, three, or the like. Because a position of the hole group 2 and the quantity of hole groups 2 causes different cutting effects on the magnetic field of the dielectric filter 10, the position of the hole group 2 and the quantity of hole groups 2 both may be designed based on actual requirements and are not limited herein.

In addition, the dielectric filter 10 shown in FIG. 1 is merely shown in a simple and intuitive cuboid structure. However, it should be understood that FIG. 1 is merely an implementation. An existence form of the dielectric filter 10 provided in this embodiment of this application is not limited to a cuboid, and may be a polyhedron. In this case, the dielectric body 11 may have a plurality of first side faces 15 and second side faces 16 along the second direction Y, or may have a plurality of top surfaces 13 and bottom surfaces 14 along the first direction Z. In this case, one end of the first hole 21 in the hole group 2 may run through any one of the plurality of top surfaces 13, the other end of the first hole 21 may run through any one of the plurality of bottom surfaces 14, and the second hole 22 runs through at least one of the plurality of first side surfaces 15 and the plurality of second side surfaces 16, provided that it can be ensured that the projections of the first hole 21 and the second hole 22 intersect in the third direction X. This is not limited herein.

Further, FIG. 3 to FIG. 5 are diagrams of structures of dielectric filters in other embodiments according to embodiments of this application.

As shown in FIG. 1 to FIG. 5, the first hole 21 may be a straight through hole to facilitate processing and formation of the first hole 21. The first hole 21 may be a vertical hole, or may be a tilted hole. Certainly, the first hole 21 may alternatively be a curved through hole, for example, may be a multi-segment bent through hole, a wavy through hole, or another through hole having an irregular channel to improve design flexibility of the first hole 21. A shape of the first hole 21 may be designed based on an actual requirement and is not limited herein.

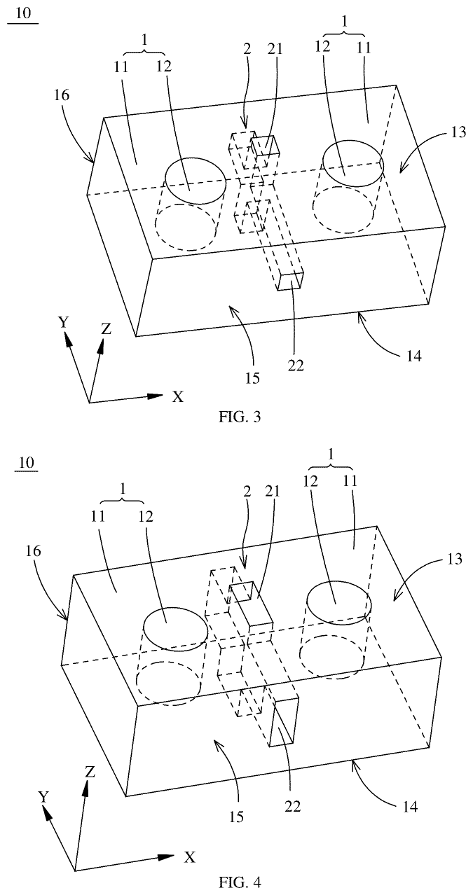

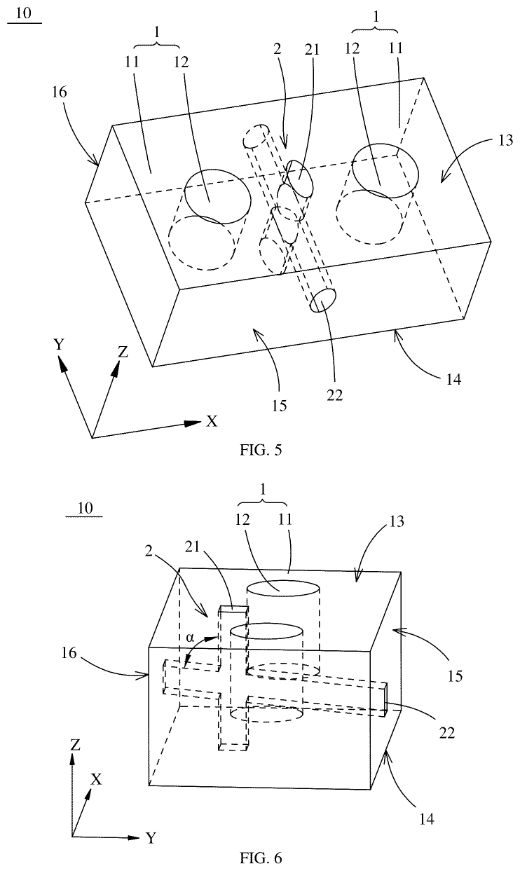

Further, a cross section of the first hole 21 may be of various shapes, for example, a simple shape such as a circle shown in FIG. 1, a square shown in FIG. 2 and FIG. 3, a rectangle shown in FIG. 4, or an ellipse shown in FIG. 5, to facilitate processing and formation of the first hole 21. Certainly, a cross section shape of the first hole 21 may alternatively be a triangle, a T shape, or another irregular shape. A cross section shape of the first hole 21 may be designed based on an actual requirement and is not limited herein.

As shown in FIG. 1 to FIG. 5, the second hole 22 may be a straight hole to facilitate processing and formation of the second hole 22. The second hole 22 may be a vertical hole, or may be a tilted hole. Certainly, the second hole 22 may alternatively be a curved hole, for example, may be a multi-segment bent hole, a wavy hole, or another hole having an irregular channel to improve design flexibility of the second hole 22. A shape of the second hole 22 may be designed based on an actual requirement and is not limited herein.

Further, a cross section of the second hole 22 may also be of various shapes (for example, a simple shape such as a circle or cylinder shown in FIG. 1, a square as shown in FIG. 2 and FIG. 3, a rectangle as shown in FIG. 4, or an ellipse as shown in FIG. 5) to facilitate processing and formation of the second hole 22. A cross section shape of the second hole 22 may alternatively be triangular, a T shape, or another irregular shape. A cross section shape of the second hole 22 may be designed based on an actual requirement and is not limited herein.

It should be noted that the first hole 21 and the second hole 22 may have a same shape and structure, or may have different shapes and structures. This may be designed based on an actual requirement and is not limited herein.

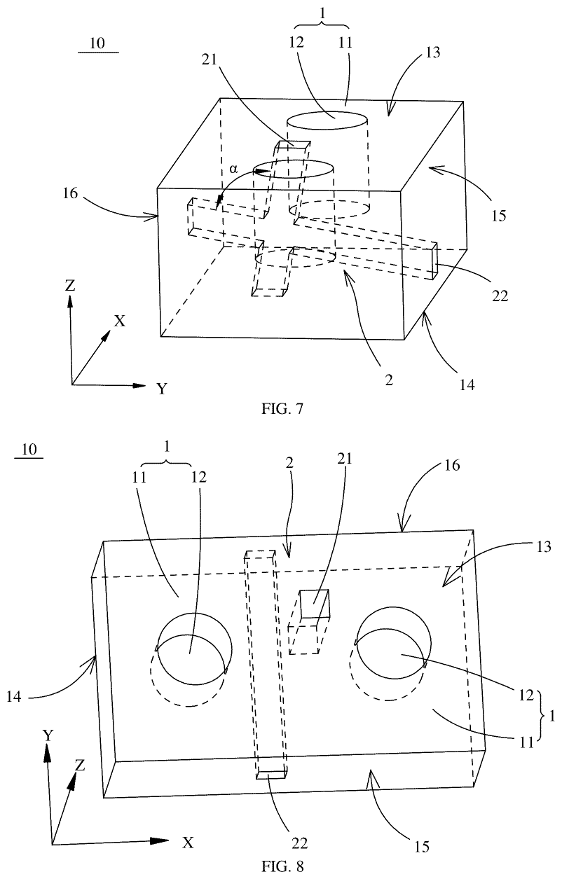

FIG. 6 and FIG. 7 are diagrams of structures of dielectric filters according to embodiments. An included angle between projections of a first hole 21 and a second hole 22 in a third direction X is an intersection angle α. At least two intersection angles α differ in magnitude. For example, the intersection angle α between the projections of the first hole 21 and the second hole 22 in the third direction X is 30°, 60°, 90°, 120°, 150°, or the like. A value of the intersection angle α may be designed based on an actual requirement and is not limited herein.

In this embodiment, as shown in FIG. 6 and FIG. 7, each hole group 2 also has a resonance frequency and the resonance frequency also affects the remote suppression capability of the dielectric filter 10. Therefore, if there are a plurality of hole groups 2 in the dielectric filter 10 and frequencies of the plurality of hole groups 2 are the same or similar, resonance frequencies of the plurality of hole groups 2 are mutually excited, increasing impact on the remote suppression capability of the dielectric filter 10. Consequently, the remote suppression capability of the dielectric filter 10 decreases. By changing an intersection angle α between the first hole 21 and the second hole 22 of the hole group 2, a resonance frequency of the hole group 2 can be adjusted. Therefore, impact of the resonance frequency of the hole group 2 on a remote suppression degree of the dielectric filter 10 can be reduced while it is ensured that the hole group 2 fully cuts the magnetic field between the two adjacent dielectric resonators 1, thereby improving the remote suppression capability of the dielectric filter 10. Particularly, in a structure in which there are a plurality of hole groups 2 in the dielectric filter 10, intersection angles α in the plurality of hole groups 2 are different so that resonance frequencies of the plurality of hole groups 2 are different, thereby reducing mutual excitation between the resonance frequencies of the plurality of hole groups 2 to reduce impact on the dielectric filter 10 and effectively improve the remote suppression capability of the dielectric filter 10.

It should be noted that when there are a plurality of hole groups 2 in the dielectric filter 10, intersections angles α of the plurality of hole groups 2 may be the same or different or partially the same in magnitude. This may be designed based on an actual requirement and is not limited herein.

In the embodiment shown in FIG. 1 to FIG. 7, in one hole group 2, a first hole 21 may be communicated with a second hole 22 to reduce space occupied by the hole group 2 in the third direction X, thereby facilitating a miniaturization design of the dielectric filter 10.

FIG. 8 is a diagram of a structure of a dielectric filter according to an embodiment. As shown in FIG. 8, the first hole 21 and the second hole 22 may alternatively be staggered, that is, the first hole 21 may not be communicated with the second hole 22.

In the embodiment shown in FIG. 8, the hole group 2 of the structure can further reduce a process requirement, formation of the hole group 2 is more convenient, and flexibility is higher. In addition, when there is another structure or component between the two adjacent dielectric resonators 1, the hole group 2 of the structure may enable more proper formation of the first hole 21 and the second hole 22 in space between the two adjacent dielectric resonators 1, thereby facilitating the miniaturization design of the dielectric filter 10.

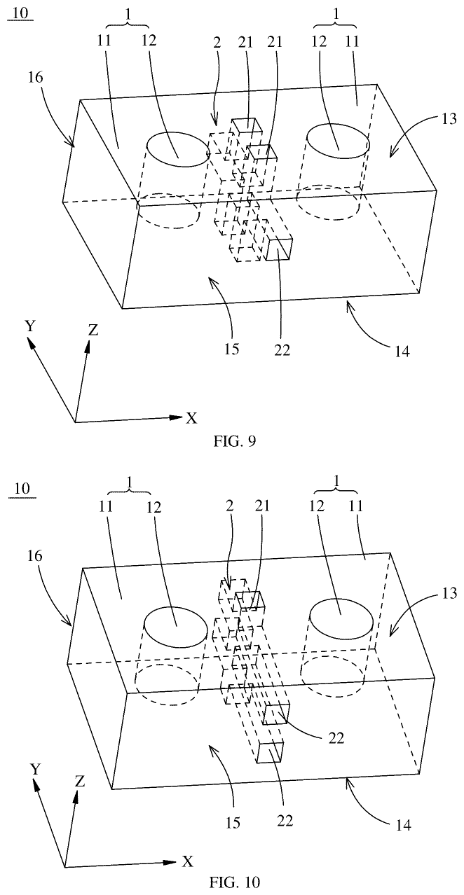

FIG. 9 is a diagram of a structure of a dielectric filter according to an embodiment. In the embodiment shown in FIG. 9, in at least one hole group 2 there are a plurality of first holes 21, and at least one first hole 21 is in communication with a second hole 22.

In the embodiment shown in FIG. 9, when there are a plurality of first holes 21, at least one of the plurality of first holes 21 is in communication with the second hole 22, or all first holes 21 may be communicated with the second hole 22. In other words, the plurality of first holes 21 may be all communicated with one second hole 22; or some first holes 21 may be communicated with one second hole 22 and other first holes 21 are not communicated with the second hole 22, to further improve design flexibility of the structure of the hole group 2, improve spatial rationality of the hole group 2 between the two adjacent dielectric resonators 1, further improve design flexibility and an adjustment range of a frequency of the hole group 2, and reduce impact of the frequency of the hole group 2 on a remote suppression degree of the dielectric filter 10.

Further, intersection angles α between projections of the plurality of first holes 21 and the second hole 22 in a third direction X may be the same, or may be partially the same, or may be different. This may be set based on an actual requirement and is not limited herein.

FIG. 10 is a diagram of a structure of a dielectric filter according to an embodiment. In the embodiment shown in FIG. 10, in at least one hole group 2 there are a plurality of second holes 22, and at least one second hole 22 is in communication with a first hole 21.

In the embodiment shown in FIG. 10, when there are a plurality of second holes 22, at least one of the plurality of second holes 22 is in communication with the first hole 21, or all second holes 22 may be communicated with the first hole 21. In other words, the plurality of second holes 22 may be all communicated with one first hole 21; or some second holes 22 may be communicated with one first hole 21 and other second holes 21 are not communicated with the first hole 22, to further improve design flexibility of the structure of the hole group 2, improve spatial rationality of the hole group 2 between the two adjacent dielectric resonators 1, further improve design flexibility and an adjustment range of a frequency of the hole group 2, and reduce impact of the frequency of the hole group 2 on a remote suppression degree of the dielectric filter 10.

Further, intersection angles α between projections of the plurality of second holes 22 and the first hole 21 in a third direction X may be the same, or may be partially the same, or may be different. This may be set based on an actual requirement and is not limited herein.

In another embodiment, one hole group 2 may alternatively have a plurality of first holes 21 and a plurality of second holes 22. The plurality of first holes 21 and the plurality of second holes 22 may all be communicated, or may be not communicated, or may be partially communicated. This may be set based on an actual requirement and is not limited herein.

It should be noted that when there are a plurality of hole groups 2 in the dielectric filter 10, the plurality of hole groups 2 may be completely the same, or may be partially the same, or may be different. This may be set based on an actual requirement and is not limited herein.

Based on different structures of the dielectric filter 10, a manner of preparing the dielectric filter 10 may also be different.

In an embodiment as shown in FIG. 1 to FIG. 10, the dielectric filter 10 may be of an integrally formed structure and at least two adjacent dielectric resonators 1 are integrally formed so that the dielectric filter 10 is prepared in a large quantity and preparation costs are reduced.

In another embodiment, two adjacent dielectric resonators 1 of the dielectric filter 10 may be formed separately first, and then the dielectric filter 10 is formed in a manner such as co-firing, that is, one of at least two adjacent dielectric resonators 1 includes a first co-fired surface 41, another includes a second co-fired surface 51. The first co-fired surface 41 is opposite to the second co-fired surface 51. The first co-fired surface 41 is provided with a first groove 42. The second co-fired surface 51 is provided with a second groove 52. The second groove 52 corresponds to the first groove 42. The first co-fired surface 41 is connected to the second co-fired surface 51. The first groove 42 and the second groove 52 are enclosed to define the first hole 21 and/or the second hole 22.

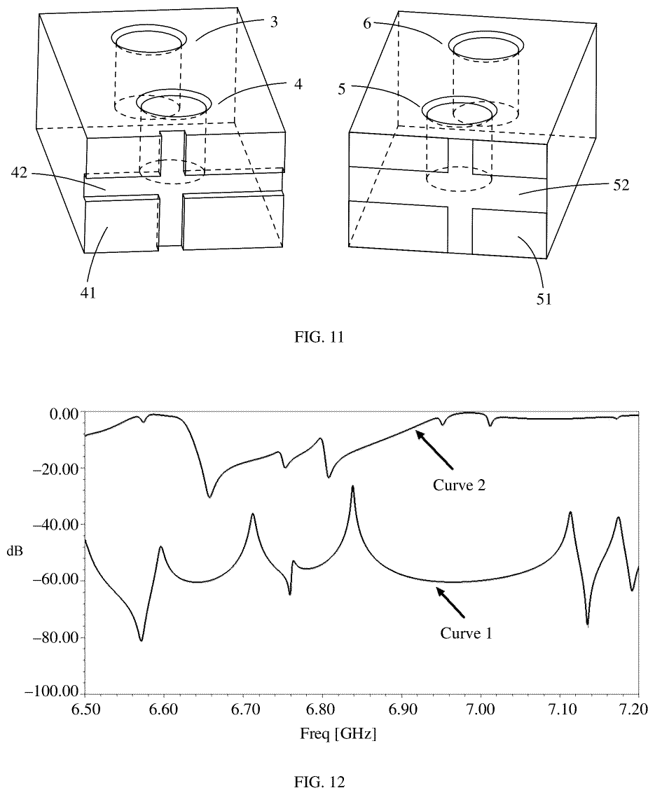

In the embodiment as shown in FIG. 11, the first groove 42 and the second groove 52 corresponding to the first hole 21 and/or the second hole 22 of the hole group 2 may be prepared in advance on the first co-fired surface 41 and the second co-fired surface 51. Therefore, when the two adjacent dielectric resonators 1 are connected by using the first co-fired surface 41 and the second co-fired surface 51, the first groove 42 and the second groove 52 are engaged and surrounded to form the first hole 21 and/or the second hole 22, thereby facilitating formation of the first hole 21 and/or the second hole 22 with a relatively complex structure and improving the design flexibility of the dielectric filter 10.

Certainly, when one dielectric filter 10 includes a plurality of dielectric resonators 1, some of two adjacent dielectric resonators 1 may be integrally formed, and other dielectric resonators 1 are co-fired, to further reduce costs and improve design flexibility.

In the embodiment shown in FIG. 11, FIG. 11 is a diagram of a structure of a dielectric filter according to an embodiment. As shown in FIG. 11, the dielectric filter 10 includes a first dielectric resonator 3, a second dielectric resonator 4, a third dielectric resonator 5, and a fourth dielectric resonator 6 that are sequentially disposed. There is no hole group 2 between the first dielectric resonator 3 and the second dielectric resonator 4. There is a hole group 2 between the second dielectric resonator 4 and the third dielectric resonator 5. There is no hole group 2 between the third dielectric resonator 5 and the fourth dielectric resonator 6.

In the embodiment shown in FIG. 11, the first dielectric resonator 3 and the second dielectric resonator 4 are integrally formed and the third dielectric resonator 5 and the fourth dielectric resonator 6 are integrally formed. The first co-fired surface 41 and the second co-fired surface 51 are respectively formed on two opposite surfaces of the second dielectric resonator 4 and the third dielectric resonator 5 and the first groove 42 and the second groove 52 are respectively formed on surfaces of the first co-fired surface 41 and the second co-fired surface 51. Finally, the second dielectric resonator 4 and the third dielectric resonator 5 are co-fired and connected by using the first co-fired surface 41 and the second co-fired surface 51. The first groove 42 and the second groove 52 are enclosed to define the hole group 2. In this way, costs can be reduced to a maximum extent, a relatively complex hole group 2 can be formed, and production efficiency is improved.

In an embodiment, a surface of at least one of the resonant cavity 12, the first hole 21, and/or the second hole 22 is coated with a metallized layer so that leakage of harmonic energy can be reduced, reliable transmission of a signal can be ensured, and signal transmission efficiency can be improved.

The metallized layer may completely cover the surface of the at least one of the resonant cavity 12, the first hole 21, and/or the second hole 22. Certainly, the metallized layer may also partially cover a surface of at least one of the resonant cavity 12, the first hole 21, and the second hole 22 to adjust a resonance frequency of the dielectric resonator 1, thereby improving a remote suppression capability of the dielectric filter 10. A structure of the metallized layer may be set based on an actual requirement and is not limited herein.

A material of the metallized layer may be a metal material such as silver or copper, and is not limited herein.

An embodiment of this application further provides a communication device including the dielectric filter 10 according to any one of the foregoing embodiments. Because the dielectric filter 10 has the foregoing technical effect, the communication device including the dielectric filter 10 should also have the corresponding technical effect. Details are not described herein again.

Further, the communication device may be, but is not limited to, a duplexer, a multiplexer, a base station, a terminal device, or the like. A form of the communication device is not limited in this embodiment of this application.

Based on the foregoing embodiments, in a same scenario, a simulation comparison diagram of a remote suppression curve of a dielectric filter provided in embodiments of this application and a remote suppression curve of a conventional dielectric filter is shown in FIG. 12. In FIG. 12, a curve 1 is the remote suppression curve of the dielectric filter provided in embodiments of this application, and a curve 2 is the remote suppression curve of the conventional dielectric filter. A horizontal axis represents a frequency, and a unit is in gigahertz (GHz). A vertical axis represents a remote suppression degree of a dielectric filter, a unit is in decibels (dB). It can be learned from FIG. 12 that coupling strength between high-order modes in a high-order harmonic wave section of the dielectric filter 10 provided in embodiments of this application is significantly reduced, thereby effectively improving the remote suppression degree of the dielectric filter 10, and helping reduce a design requirement of removing a low-pass filter to reduce insertion losses in a communication device system.

The foregoing descriptions are merely implementations of embodiments of this application and are not intended to limit the protection scope of embodiments of this application. Any variation or replacement within the technical scope disclosed in embodiments of this application shall fall within the protection scope of embodiments of this application. Therefore, the protection scope of embodiments of this application shall be subject to the protection scope of the claims.

1. A dielectric filter, comprising:
at least two dielectric resonators connected to each other, each dielectric resonator of the at least two dielectric resonators comprising:
a dielectric body; and
a resonant cavity;
the dielectric body comprising:
a top surface and a bottom surface along a first direction Z of the dielectric filter, the resonant cavity running through the top surface or the bottom surface; and
a first side surface and a second side surface along a second direction Y of the dielectric filter; and
at least one hole group disposed between two adjacent dielectric resonators of the at least two dielectric resonators, each hole group of the at least one hole group comprising a first hole and a second hole, two ends of the first hole run through the top surface and the bottom surface respectively, and the second hole runs through at least one of the first side surface or the second side surface;
wherein projections of the first hole and the second hole intersect along a third direction X of the dielectric filter.

2. The dielectric filter according to claim 1, wherein an included angle between the projections of the first hole and the second hole in the third direction X is an intersection angle; and
at least two intersection angles differ in magnitude.

3. The dielectric filter according to claim 1, wherein in the at least one hole group, the first hole is in communication with the second hole.

4. The dielectric filter according to claim 1, wherein in the at least one hole group, the first hole and the second hole are staggered.

5. The dielectric filter according to claim 1, wherein the at least one hole group includes a plurality of first holes, and at least one first hole of the plurality of first holes is in communication with the second hole.

6. The dielectric filter according to claim 1, wherein the at least one hole group includes a plurality of second holes, and at least one second hole of the plurality of second holes is in communication with the first hole.

7. The dielectric filter according to claim 1, wherein one dielectric resonator of the at least two adjacent dielectric resonators comprises a first co-fired surface, another dielectric resonator comprises a second co-fired surface, and the first co-fired surface is opposite to the second co-fired surface;
the first co-fired surface is provided with a first groove;
the second co-fired surface is provided with a second groove corresponding to the first groove; and
the first co-fired surface is connected to the second co-fired surface and the first groove and the second groove define the first hole and/or the second hole.

8. The dielectric filter according to claim 1, wherein the at least two adjacent dielectric resonators are integrally formed.

9. The dielectric filter according to a claim 1, wherein the first hole is a straight through hole or a curved through hole.

10. The dielectric filter according to claim 9, wherein a cross section of the first hole is one of rectangular, circular, elliptical, triangular, or T-shaped.

11. The dielectric filter according to claim 1, wherein the second hole is a straight hole or a curved hole.

12. The dielectric filter according to claim 11, wherein a cross section of the second hole is one of rectangular, circular, elliptical, triangular, or T-shaped.

13. The dielectric filter according to claim 1, wherein a surface of at least one of the resonant cavity, the first hole, or the second hole is coated with a metallized layer.

14. A communication device comprising a dielectric filter, the dielectric filter comprising:
at least two dielectric resonators connected to each other, each dielectric resonator of the at least two dielectric resonators comprising:
a dielectric body; and
a resonant cavity;
the dielectric body comprising:
a top surface and a bottom surface along a first direction Z of the dielectric filter, the resonant cavity running through the top surface or the bottom surface; and
a first side surface and a second side surface along a second direction Y of the dielectric filter; and
at least one hole group disposed between two adjacent dielectric resonators of the at least two dielectric resonators, each hole group of the at least one hole group comprising a first hole and a second hole, two ends of the first hole run through the top surface and the bottom surface respectively, and the second hole runs through at least one of the first side surface or the second side surface;
wherein projections of the first hole and the second hole intersect along a third direction X of the dielectric filter.

15. The communication device according to claim 14, wherein an included angle between the projections of the first hole and the second hole in the third direction X is an intersection angle; and
at least two intersection angles differ in magnitude.

16. The communication device according to claim 14, wherein in the at least one hole group, the first hole is in communication with the second hole.

17. The communication device according to claim 14, wherein in the at least one hole group, the first hole and the second hole are staggered.

18. The communication device according to claim 14, wherein the at least one hole group includes a plurality of first holes, and at least one first hole of the plurality of first holes is in communication with the second hole.

19. The communication device according to claim 14, wherein the at least one hole group includes a plurality of second holes, and at least one second hole of the plurality of second holes is in communication with the first hole.

20. The communication device according to claim 14, wherein a surface of at least one of the resonant cavity, the first hole, or the second hole is coated with a metallized layer.
